(19) United States
(12) Patent Application Publication
(10) Pub. No.: US 2024/0208153 A1
(43) Pub. Date: Jun. 27, 2024

(54) Separation Control Systems and Methods for 3D Printers

(71) Applicant: Currax Advanced Research Laboratories Inc., Kelowna (CA)

(72) Inventor: Barry Alan Mills, Kelowna (CA)

(21) Appl. No.: 18/556,688

(22) PCT Filed: Apr. 21, 2022
(86) PCT No.: PCT/CA2022/050610

§ 371 Date: Oct. 23, 2023

Related U.S. Application Data
(60) Provisional application No. 63/178,615, filed on Apr. 23, 2021.

(51) Int. Cl. B29C 64/393; B29C 64/232; B29C 64/236; B29C 64/245; B29C 64/255; B33Y 30/00; B33Y 50/02

(52) U.S. Cl. CPC B29C 64/393; B29C 64/232; B29C 64/236; B29C 64/245; B29C 64/255; B33Y 30/00; B33Y 50/02

(57) ABSTRACT

Methods and apparatus for releasing a 3D stereolithographic printed layer from a vat of resin are disclosed. The apparatus comprises: a vat having a release layer and configured to contain solidifiable resin; and one or more release mechanisms including a build plate which is configured to adjust the position and orientation of the object being printed with respect to a release layer.

### FIELD OF THE INVENTION

The invention relates to 3D printing and, in particular, to photo-solidification printers.

### BACKGROUND

Photo-solidification (may also be known as Stereolithography, Photo-Solidification, Solid Free-Form Fabrication, Solid Imaging, Rapid Prototyping, Resin Printing, and 3D printing) is a form of additive manufacturing technology used for creating models, prototypes, patterns, and production parts in a layer-by-layer fashion using photopolymerization, a process by which light causes chains of molecules to link together, forming polymers.

One type of stereolithography is an additive manufacturing process that works by focusing an energy source on to a vat of photopolymer resin. With the help of computer aided manufacturing or computer aided design software (CAM/CAD), energy source is used to draw a pre-programmed design or shape on to the surface of the photopolymer vat. Because photopolymers are photosensitive, the resin is solidified and forms a single layer of the desired 3D object. This process is repeated for each layer of the design until the 3D object is complete.

Another type of stereolithography uses ‘bottom-up’ manufacturing. Such systems have an elevator platform which descends to a distance equal to the thickness of a single layer of the design into the liquid photopolymer. Then portions of the liquid photopolymer between the object or platform and the vat base are cured to cause the liquid to solidify. A complete 3D object can be formed using this process.

An issue with the ‘bottom-up’ manufacturing is that when the liquid photopolymer is cured it adheres not only with the previously cured layer, but also to the vat itself. Therefore, there is a need for a system which allows the newly cured layer to be separated from the vat, without pulling the object off the build plate.

### SUMMARY

According to a first aspect, there is provided a release assembly apparatus for a 3D printer, the release assembly comprising:
a vat configured to contain solidifiable resin and having a release layer, the release layer being configured to transmit solidification energy from a solidification energy source into the vat of solidifiable resin to solidify at least a portion of the solidifiable resin in contact with the release layer;
a configuration mechanism including a build for supporting an object being printed, the configuration mechanism being configured to control the position of the object with respect to the release layer; and
a force sensor configured to measure the force applied to the object as the release layer is moving with respect to the object being printed.

The release assembly may comprise a frame. The release layer and the build plate may be independently mounted to the frame using separate actuators. An actuator may be considered to be a component of a machine that is responsible for moving and controlling a mechanism or element.

The release assembly may comprise a 3-DoF mount. The 3-DoF mount may comprise multiple actuators configured to enable the release layer to tilt about two axes and to move up and down. The 3-DoF actuators may be upright actuators configured to extend and retract in a direction aligned with the vertical.

A 3-DoF mount may be combined with a rotation actuator configured to rotate the release layer about a rotation axis aligned with a vertical Z-axis (e.g., to induce yaw). This rotation, or yaw, may help release the cured layer when the 3-DoF has tilted to induce partial separation of the release layer and the cured layer. This combination of a 3-DoF mount with a rotation actuator would provide 4 degrees of freedom.

Each actuator may be connected to a respective force sensor. Each upright actuator may be mounted on a respective force sensor.

The release assembly may comprise a sliding-floor mount comprising multiple actuators configured to move the release layer laterally in any direction.

The release assembly may comprise a frame and wherein the configuration mechanism is configured to move the release layer with respect to the frame with at least 5 degrees of freedom. For example, the 3-DoF mount in combination with the sliding-floor mount would provide 5 degrees of freedom. Adding a rotation actuator to facilitate yaw would provide 6 degrees of freedom (i.e., a 6-DoF mount).

The configuration mechanism may comprise a 6-DoF mount. The 6-DoF mount may comprise six actuators configured to control the position of the release layer with respect to the frame. The actuators may be rotary actuators.

The six actuators of the 6-DoF mount may be mounted in pairs. Each pair may be rigidly attached to each other by being connected directly together or connected to a common rigid mount. Each pair may comprise two actuators positioned close together (e.g., side by side). At least one of the force sensors may be positioned below one of the rotary actuator pairs and/or between the actuators and the frame.

The release assembly may comprise a platform-frame lock having complementary platform-frame engagement members configured to releasably lock the release layer in fixed position with respect to the frame in a reproduceable relative position.

The 6-DoF mount may be connected to the release layer via a resilient mount.

The vat may have a circular cross section in a horizontal plane. A circular cross section may help mitigate inducing turbulence in the resin in the vat when the vat is rotated about a vertical axis. The vat may have a rectangular or square cross section in a horizontal plane. A rectangular or square vat may make is easier to accommodate one or more conventional rectangular LCD solidification energy sources.

The vat and the solidification energy source may be joined together as a rigid solidification unit. The release assembly may comprise a platform-unit lock having complementary platform-unit engagement members configured to releasably lock the solidification unit to the 6-DoF mount. This may facilitate easy removal of the solidification unit for repair. The platform-unit lock may be manually controlled or controlled via a controller.

The solidification unit may comprise multiple LCD units. Each LCD unit may have 50-micron resolution or higher. Each LCD unit may be rectangular with a diagonal of at least 9 inches.

The configuration mechanism may be configured to control the orientation of the object being printed with respect to the release layer. The configuration mechanism may comprise actuators configured to control the position and orientation of the release layer.

The release assembly may be configured to adjust the separation speed of build plate towards the release layer based on the measured force. The release assembly may be configured to adjust the approach speed of build plate towards the release layer based on the measured force. The approach may occur after separation where the release layer is moving towards the build plate until the release layer is separated from the previously printed layer by a layer thickness. Then the printer is ready to cure another layer. During the approach, resin may be squeezed out from between the previously printed layer and the release layer. This may exert a force on the printed object.

The release assembly may comprise actuators configured to tilt the release layer with respect to the build plate (and the most-recently cured layer).

The release assembly may comprise actuators configured to tilt the release layer such that the release layer is not parallel with the build plate as the as the build plate is moving towards the release layer (e.g., during the approach phase) This may help direct resin out from between the previously printed layer and the release layer.

The release assembly may comprise four force sensors arranged at each corner of a quadrilateral. The actuators may be arranged at each corner of a quadrilateral. This may allow the release layer to be tilted about two axes. Each actuator may have a corresponding force sensor.

The release assembly may comprise actuators configured to tilt the release layer and a solidification energy source as a unit.

The release layer may comprise a resilient layer attached to an underlying rigid surface. The attachment may be configured such that portions of the resilient layer can lift away from the underlying rigid surface during separation.

The release assembly may be configured to adjust the approach speed of the object being printed based on the rate of change of measured force as the build plate is moving towards the release layer.

The release assembly may be configured to adjust the separation speed of the object being printed based on the rate of change of measured force as the build plate is moving away from the release layer.

The release assembly may comprise actuators to tilt and separate the release layer from a cured layer, and wherein the build plate is configured to translate rigidly along a single axis.

The release assembly may be configured to tilt and translate the release layer to effect separation from a stationary build plate.

The release assembly may be configured to translate the build plate after separation by an amount corresponding to the predetermined thickness of the next layer to be printed. After separation, the release assembly may be configured to translate the build plate no more than an amount corresponding to the predetermined thickness of the next layer to be printed.

The release layer may be configured move from a printing position to effect separation, and return to the printing position after separation (e.g. with respect to a stationary frame of reference).

The release assembly may be configured to control the motion of the build plate with respect to the release layer based on the measured force.

The release assembly may be configured to determine the volume of resin within the vat. This may be used to adjust for the weight of the resin when taking force measurements.

The release assembly may be configured to control the motion of the build plate with respect to the release layer based on absolute value of the measured force.

The release assembly may be configured to increase separation speed if the force is below a low threshold value. The release assembly may be configured to apply a higher separation speed for a higher measured force.

The release assembly may be configured to stop separating the build plate from the release layer in response to detecting a decrease in measured force at a rate higher than a predetermined force-drop rate threshold.

The release assembly may be configured to stop separating the build plate from the release layer in response to detecting a decrease in measured force to below a release threshold value.

The release assembly may be configured to control the one or more configuration mechanisms based on the measured force and the area cured in the last curing step.

The release assembly may be configured to control the one or more configuration mechanisms based on the measured force and the shape of the last printed layer.

An actuator may be considered to be a component that moves and controls a mechanism or system. An actuator may be activated in response to a control signal. An actuator may be a linear actuator or a rotary actuator. A linear actuator may be considered to be an actuator that creates motion in a straight line. A linear actuator may comprise a hydraulic or pneumatic cylinder. A linear actuator may comprise a mechanical actuator.

The release assembly may be configured to:
record data on measured forces on each of the force sensors as a function of time, configuration of each layer, and configuration of the configuration mechanism as a function of time,
store the recorded data in association with information on the resin being used;
receive feedback on the quality of the printed objects; and
adjust how the configuration mechanism responds to a measured force to reduce a rate of printing defects and increase the speed of printing.

The configuration of the configuration mechanism may comprise information on the position and/or speed of the build plate and/or of each of the actuators.

The configuration of each layer of the printed object may comprise information on the area of the layer, the shape of the layer, and the position of the layer with respect to the release layer with respect to each actuator.

According to a further aspect, there is provided a method for controlling the release of an object being printed from a 3D printer, the method comprising:
curing a layer of resin between an object being printed and a release layer, the release layer being configured to transmit solidification energy from a solidification energy source into the vat of solidifiable resin to solidify at least a portion of the solidifiable resin in contact with the release layer;
moving the object with respect to the release layer to release the object being printed;
measuring the force applied to the object being printed as it is moving with respect to the release layer; and
controlling one or more configuration mechanisms based on the measured force.

It will be appreciated that because the build plate and the release layer may both move independently, such movement may be defined with respect with a stationary reference frame. The stationary reference frame may be for example, the surface on which the 3D printer (which comprises the release assembly) is sitting and/or the anchor points to which the actuators and build plate are attached. E.g. each actuator may be attached at one end to the release layer and at another end to an anchor point. Shortening or lengthening the actuator causes the release layer to move with respect to the stationary anchor point.

The build plate may translate up and down along a single axis (no tilting or rotation) with respect to the stationary reference frame. The release layer may be configured to tilt (and possibly translate) with respect to the stationary reference frame.

The release assembly apparatus may be configured to control one or more release mechanisms. Controlling the release mechanisms may comprise one or more of: starting the release mechanism; stopping the release mechanism; changing the intensity of the release mechanism. A release mechanism may be any mechanism which facilitates or causes release of the object being printed from the release layer. Release mechanisms may include one or more of: moving the build plate; moving the release layer; and vibrating the release layer.

The release assembly apparatus may be configured to control the motion of the release layer with respect to the build plate based on the measured force. The apparatus may be configured to take into account the weight of the object being printed. The force may be measured by one or more force sensors at a range of locations within the apparatus (e.g. at the build plate, at the release layer). From these measurements, the force between the release layer and the object being printed may be determined.

The release assembly apparatus may be configured to control the motion of the build plate with respect to the release layer based on absolute value of the measured force.

The release assembly apparatus may be configured to slow down if the force is above a threshold force value.

The release assembly apparatus may be configured to increase speed if the force is below a low threshold value.

The release assembly apparatus may be configured to control the motion of the build plate with respect to the release layer based on the rate of change of the measured force.

The release assembly apparatus may be configured to stop separating the build plate from the release layer in response to detecting a decrease in measured force at a rate higher than a predetermined force-drop rate threshold. The force-drop rate threshold may be 97% decrease in force per second. Other thresholds may be used. For example, the force-drop rate threshold may be 80% decrease in force per second, or 50% decrease in force per second.

The release assembly apparatus may be configured to stop separating the build plate from the release layer in response to detecting a decrease in measured force to below a release threshold value.

The release assembly apparatus may be configured to control a secondary release mechanism based on the measured force.

The release assembly apparatus may be configured to initiate the secondary release mechanism in response to measuring a force above a secondary-release threshold force value.

The release assembly apparatus may be configured to control the one or more release mechanisms based on the measured force and the area cured in the last curing step.

The release assembly apparatus may be configured to control the one or more release mechanisms based on the measured force and the shape of the last printed layer.

The one or more release mechanisms may include a vibration actuator connected to the release layer, wherein the apparatus is configured to vibrate the release layer using the vibration actuator to effect release of the solidifiable resin from the release layer.

The release assembly apparatus may be configured to assign a cure value for each area of the layer being printed (e.g. each pixel of the object being printed). The cure value may correspond to the total quantity of energy required from the energy source over a curing cycle to cure that area. The release assembly apparatus may be configured to adjust the cure time of each area based on the assigned cure value. The release assembly apparatus may be configured to adjust the light intensity of the energy source applied to each area based on the cure value. The release assembly apparatus may be configured to adjust the light intensity so that all the areas take the same amount of time to be cured.

The apparatus may be capable though algorithmic interpolation of different geometries to determine the approximate cure-time and release force required for a properly cured layer. Using the estimates for cure-time the system can create the optimum cure-times for each image (and each region) on each layer. Furthermore by understanding the forces required in the release the system will be able to make real-time refinements of the cure-times to help make more accurate and reliable parts.

The apparatus may be able to determine through a database of forces and measured parts, suitable supports for given geometries that will decrease separation force and reduce deformation of features in prints.

The release assembly apparatus may be configured to vibrate the release layer at a sonic or ultrasonic frequency. Ultrasonic may be considered to relate to frequencies greater than 20 kHz. Sonic may be considered to relate to frequencies 20 Hz and 20 KHz

The release assembly apparatus may be configured to vibrate the release layer at a frequency between 30 Hz to 70 kHz (or 80 kHz).

The release assembly apparatus may be configured to vibrate the release layer at a frequency between 30 Hz and 80 Hz.

The one or more release mechanisms may comprise a build plate configured to control the position of the object being printed with respect to the release layer;
wherein the apparatus comprises a force sensor configured to measure the force applied to the build plate as it is moving away from the release layer to release the object being printed; and
wherein the apparatus is configured to control the one or more release mechanisms based on the measured force.

The release assembly apparatus may comprise multiple vibration actuators.

The separation boundary may be considered to be the boundary between the portion of the printed object connected to the release layer and the portion which has released from the release layer.

The tilting axis of the release layer may be considered to be the axis around which the release layer is rotating. The tilting axis will typically be in the plane of the release layer.

The release assembly apparatus may form part of a 3D printer. The printer may comprise a two-dimensional light source (e.g. an LCD). The light source may comprise pixels which can be selectively turned on and off to cure a layer of the three-dimensional object. The layer will have a particular two-dimensional shape.

A 6-DoF mount is a type of parallel manipulator that has six prismatic actuators, commonly hydraulic jacks or electric linear actuators, attached in pairs to three positions on the platform's baseplate, crossing over to three mounting points on a top plate. All 12 connections may be made via universal joints or heim joints to allow a range of motion in the required directions. Devices placed on the top plate can be moved in the six degrees of freedom in which it is possible for a freely-suspended body to move: three linear movements x, y, z (lateral, longitudinal, and vertical), and the three rotations (pitch, roll, and yaw).

6-DoF mount are known by various other names. In many applications it is commonly referred to as a motion base. It is sometimes called a six-axis platform, a Stewart platform or synergistic motion platform.

The six degrees of freedom of a 6-DoF mount are divided in two motional classes as described below
Translational envelopes:
   Moving forward and backward on the X-axis. (Surge)
   Moving left and right on the Y-axis. (Sway)
   Moving up and down on the Z-axis. (Heave)
Rotational envelopes:
   Tilting side to side on the X-axis. (Roll)
   Tilting forward and backward on the Y-axis. (Pitch)
   Turning left and right on the Z-axis. (Yaw)

The release assembly may comprise a heat controller configured to maintain the resin temperature at a predetermined value (e.g., 65° C.) or within a predetermined range (e.g., between 30-80° C. or between 60-80° C.). The heat controller may comprise a heater and/or a cooler.

The release assembly apparatus may comprise a control system or controller. The control system may comprise a processor and memory. The memory may store computer program code. The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a front cross-sectional view of an embodiment of a 3D printer.

FIG. 1b is a perspective view of the vat and vibration actuators of the 3D printer of FIG. 1a.

FIG. 2a-2f is a series of front cross-sectional views of an embodiment of a 3D printer showing how a layer is added to a 3D object being printed.

FIG. 3 is a flow chart showing how the embodiment of FIG. 1a is used to print an object.

FIG. 4a is a perspective view of a further embodiment of a 3D printer.

FIGS. 4b and 4c are perspective views of the 6-DoF mount of the embodiment of FIG. 4a.

FIG. 4d is a perspective view of the mountings of the 6-DoF mount connect with the frame of the embodiment of FIG. 4a.

FIG. 4e is a perspective view of the platform-frame lock of the embodiment of FIG. 4a.

FIG. 4f is a perspective view of the solidification unit and part of the unit-frame lock of the embodiment of FIG. 4a.

FIGS. 4g and 4h are perspective views of the solidification unit platform of the embodiment of FIG. 4a.

FIG. 5a is a perspective view of a further embodiment of a 3D printer.

FIG. 5b is a front view of the embodiment of FIG. 5a.

FIG. 5c is a perspective view of the solidification unit platform and vat of the embodiment of FIG. 5a.

### DETAILED DESCRIPTION

With reference to the figures, apparatus and methods are described which facilitate the release of a 3D printed object from a release layer within a vat of resin.

All terms have definitions that are reasonably inferable from the drawings and description.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### Release Assembly Apparatus

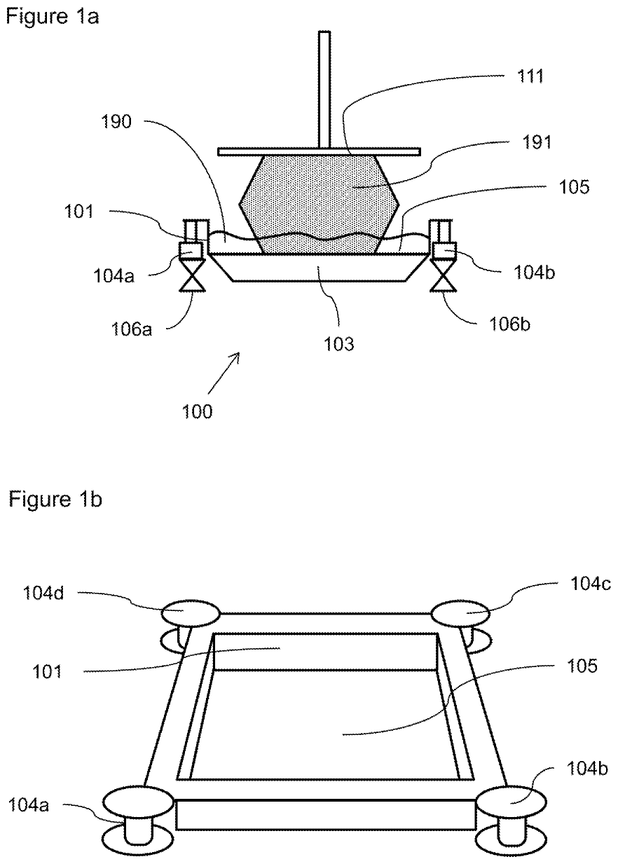

FIGS. 1a-b show an embodiment of a 3D printer comprising a release assembly 100. In particular, the release assembly 100 comprises:
a vat 101 configured to contain solidifiable resin 190 and having a release layer 105, the release layer being configured to transmit solidification energy from a solidification energy source 103 into the vat of solidifiable resin to solidify at least a portion of the solidifiable resin in contact with the release layer;
a configuration mechanism including a build plate 111 configured to control the position of the object 191 being printed with respect to the release layer; and
one or more force sensors 106a-b configured to measure the force applied to the object being printed as it is moving with respect to the release layer.

In this case, the release layer 105 is the base of the vat 101.

In this case, the vat is mounted on multiple linear actuators 104a-d configured to move the vat. These actuators also from part of the configuration mechanism as they cam move the release layer with respect to the object being printed. Each actuator 104a-d is associated with a respective force sensor 104a-b (two force sensors are not shown) configured to measure the force exerted through each actuator.

In this case the release assembly is configured to pull the release layer away from the printed object by lowering the release layer 105 away from the build plate 111 using the multiple actuators 104a-d. This applies an extension force on the object being printed. The elasticity and/or rigidity of the printed material and or the release layer will cause separation of the object from the release layer.

The energy source 103 in this case is an LCD screen which is configured to cure successive layers of the object being printed. Using a screen with pixels may allow the entire layer of be solidified simultaneously. Other light sources may include lasers, fluorescent lamps, gas-discharge lamps and incandescent lamps. Pixels may be provided by turning on and off particular light-sources within a light-source array and/or by blocking portions of light (e.g. using a liquid crystal assembly comprising a liquid crystal layer sandwiched between polarizers). In this case, the LCD screen is rigidly attached to the release layer. This means that the release layer 105 and the energy source 103 move and tilt together in response to the actuators moving. This ensures that the position of the energy source with respect to the release layer is kept constant throughout the printing process.

The energy source may comprise an LCD assembly being configured to emit UV light (e.g. between 375 and 395 nm or up to 420 nm). For example, the LCD assembly may comprise: a light source configured to emit light with a wavelength between 375-420 nm; first and second polarizers with a crossed polarization axes; and a liquid crystal layer positioned between the polarizers, wherein the LCD assembly is configured such that when light from the source is passed through the first and second polarizers and the LCD, the emitted light has a maximum spectral intensity between 375-420 nm.

The force sensors 106a-b in this embodiment are load cells are configured to relay information back to the printer (e.g. to a controller) to allow the printer (or controller) to adjust dynamically how the printer separates the part 191 from the release layer 105 (e.g. by controlling operation of the configuration mechanism).

### 3D Printing

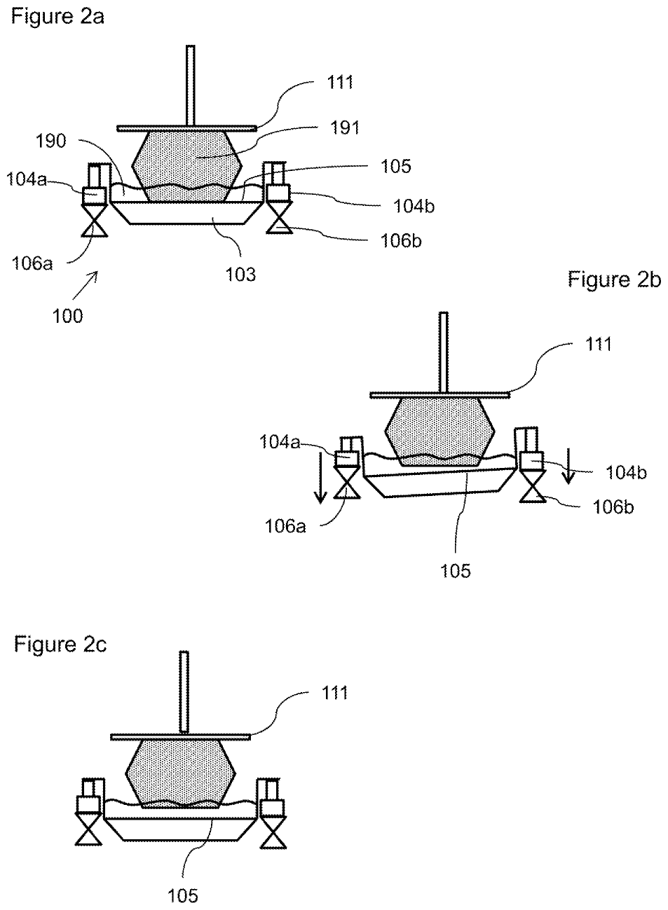

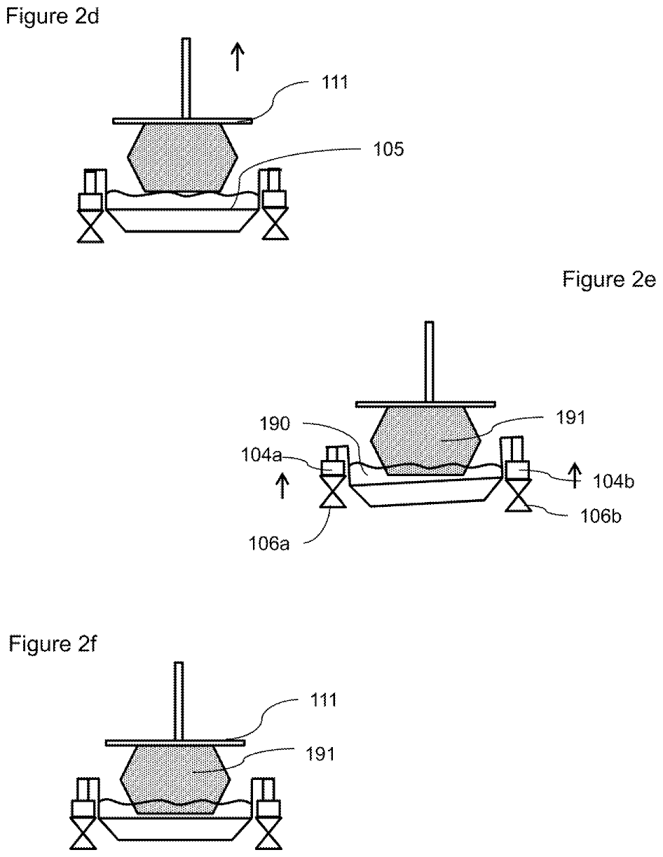

FIG. 2a-2f is a series of front cross-sectional views of the embodiment of a 3D printer of FIGS. 1a-b showing how a layer is added to a 3D object being printed.

FIG. 2a shows the situation when a layer of the resin has been cured onto a previously cured object 191 which is in the process of being printed.

In order to continue (or complete) printing, the newly solidified layer needs to be detached from the release layer 105. To do this, as shown in FIG. 2b, the release layer 105 is lowered away from the build plate 111 by reducing the length of linear actuators 104a-d. In this case, the entire vat 101 and energy source 103 are lowered with the release layer 105 as a unit. In this embodiment, the build plate does not move during release (e.g. with respect to a stationary reference frame).

As the release layer 105 is lowered a force sensor 106a-b associated with each actuator 104a-d is configured to monitor the force applied to the object by that actuator. In this case, the release assembly is configured to adjust the speed of each actuator during separation based on measured force and/or the rate of change of measured force as the release layer is moving away from the build plate. It will be appreciated that the release assembly may be configured to adjust the speed of each actuator based on the force measurement of that actuator along (i.e. completely independent operation), or using a combination of the forces measured at all the actuators. For example, the speed of each actuator may be increased until a maximum force is measured at that actuator, unless the total force of all the actuators exceed a predetermined aggregate force threshold.

Generally, if the force is high at a particular actuator, the speed of separation may be slow, whereas if the force is relatively low, the speed of separation may be relatively fast. Likewise, if the force on a particular actuator is decreasing, the speed of lowering of that actuator may be increased. This will increase the rate of separation while help ensure that the printed object is not damaged during separation. In some embodiments, the speed of separation may be increased until the force reaches a predetermined threshold value.

As shown in FIG. 2b, adjusting the speed of each actuator separately causes the vat to tilt as separation is underway. This tilting allows the separation boundary to be better controlled than using a simple axial separation along an axis perpendicular to the connected surface. Tilting the release layer (rather than the build plate) may be more effective because the release layer is closer to the connected layer being released than the build plate (which is separated from the connected layer being released by the previously printed object).

Because there are four actuators arranged in a quadrilateral, the release layer may be tilted about any axis within the plane of the release layer. For example, in the situation in FIG. 2b, lowering the left side before the right induces a tilt about an axis out of the page. Lowering the front left actuator by a large amount, lowering the front right and back left actuators by a small amount and keeling the back right actuator stationary would induce a tilt about an axis which passes through the back left and front right of the release layer.

In some embodiments, the actuators are configured to initially induce a tilt in the release layer by starting the lowering of one or more of the actuators before the rest of the actuators to help control the separation boundary.

In this case, the four actuators are constrained to move in consort such that the release layer remains in a flat plane. For example, one actuator can not lower and the other three remain stationary as this would induce a bending force onto the release layer. The release assembly may be configured to control the actuators in order that the tilting axis rotates as the release layer is lowered (e.g. from north to east to south to west and back to north). Other embodiments may be configured to induce a bending force onto a resilient release layer.

FIG. 2c shows the situation when the separation is complete. The uncured liquid resin 190 has flowed into the gap between the bottom of the printed object portion and the release layer.

In this case, after separation is complete (as shown in FIG. 2c), the build plate 111 is configured to move the thickness of one printed layer upwards (e.g. in a stationary reference from) from the release layer 105 (one printed layer may be between e.g. 0.05 mm to 0.20 mm thick). This is shown in FIG. 2d. Moving the actuators and the build plate separately allows the build plate to move one layer at a time. Allowing the release layer and the build plate to move independently may allow the actuators to be tailored to their function. For example, the actuator used to move the build plate one-layer thickness at a time may be configured to be more accurate than if the build plate were required both to effect separation and to define the layer thickness.

As shown in FIG. 2e, the release layer is then returned to its original position. In this case, the vat is returned to its original position using hard stops which prevent the vat from being moved further upwards. These stops help ensure that the position of the release layer is more reproduceable before curing begins on each layer (e.g., within 5 μm or better accuracy or within 1 μm or better accuracy). The stops may be incorporated into the actuators (e.g., such that the release layer halts when the actuators reach the end of their travel), or be separate (e.g., such that the release layer halts when they hit the separate stops).

In this case, the release layer is held in a tilted configuration as it approaches the build plate (and the previously printed object). By holding the release layer in a tilted position, resin is directed out from between the release layer and the previously printed layer as the release layer and the previously printed layer are brought together. This helps prevent damaging forces being applied to the printed object, and most-recently cured layer. In addition, compression waves are dissipated. Recently, it has been found that more viscous resins can often produce better printed results. However, during the approach phase, a high viscosity resin can cause damage to the printed object as it may be difficult to squeeze it out from between the release layer and the printed object.

In this case, the force is measured for each actuator 104a-b as the release layer and the previously printed layer are brought together. Once one side hits or approaches the respective stop, the other actuators continue to raise their portion of the release layer until it is parallel to the bottom of the object being printed.

When the release layer has stopped, as shown in FIG. 2f, then the next layer of the object can be printed by selectively turning on pixels which cure portions of the liquid layer between the release layer and the printed object portion. This returns the apparatus to a situation similar to that of FIG. 2a (with an additional layer added). By iteratively curing, releasing and moving the build plate, the 3D object can be built up in layers.

### Release Assembly Monitoring

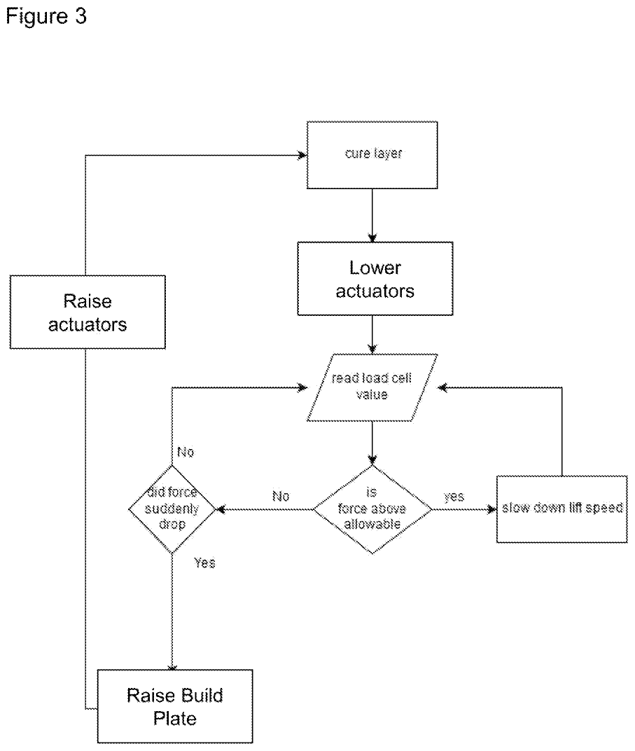

The method of operation of release mechanisms of the embodiment of FIG. 1a is shown in FIG. 3.

One mode of operation shown in FIG. 3 is that the force sensors comprises one or more load cells. These load cells monitor the force applied to the printed object as the release layer is lowered. Initially the measured force will rise as strain is put on the printed object as it is extended. When the newly cured bottom layer begins to detach from the release layer, the strain will be released and the force on the build plate will decrease.

In this embodiment, the load cells are configured to detect a sudden drop in force when separating the printed object 191 from the release layer. The printer (or controller) in this case is configured to determine from the sudden drop in force when the object has successfully separated from the release layer (FIG. 1b). A load cell may be considered to be a transducer that is used to create an electrical signal whose magnitude corresponds (e.g. is directly proportional) to the force being measured. A load cell may comprise, for example, a hydraulic load cell, a pneumatic load cell and/or a strain-gauge load cell.

That is, in this case, the apparatus is configured to control the motion of the release layer with respect to the build plate based on the rate of change of the measured force. For example, the apparatus may be configured to stop separating the build plate from the release layer in response to detecting a decrease in measured force at a rate higher than a predetermined force-drop rate threshold. For example, the force-drop rate threshold may be dependent on the resin and print build area etc. The force-drop rate threshold may be 97% decrease in force per second. For example, if the force were measured in 0.1 second intervals, the threshold would be 9.7% per 0.1 second interval. Other thresholds may be used. For example, the force-drop rate threshold may be 80% decrease in force per second, or 50% decrease in force per second.

One setup may be designed to detect a drop of 90%/sec measured over 0.1 sec increments and sustain that for five increments. These values may change depending on the resin used and could be on the layer geometry. Thresholds may be absolute thresholds (e.g. a force threshold may be given in newtons) or relative thresholds (e.g. a force threshold may be given as a proportion of the maximum force measured during separation).

Other parameters may also be considered. For example, the apparatus may be configured to stop separating the build plate from the release layer in response to one or more of: detecting a decrease in measured force to below a release threshold value; and the separation distance between the release layer and the object being printed exceeding a predetermined threshold.

After release is detected, the apparatus may be configured to move directly to allow the next curing step to occur. This would allow the printer to only lift the amount required to peel each layer and quickly (e.g. instantly) start moving to the start position (for the next curing step). This may reduce the time between curing operations as significant time can be wasted in bottom down printing by lifting the printed object further than is required to effect separation.

In addition to adjusting the maximum separation distance between curing operations (e.g. by stopping raising the build plate after release is detected), the apparatus may also dynamically adjust the separation speed. If the release force starts to reach a value where separation of the part 108 from the build plate 104 would be considered a possibility during the separation (FIG. 2b) the load cell setup could tell the printer to slowdown the lifting mechanism allowing it to peel of easier from the vat and stay on the build plate. This would allow the printer to increase speed as the lift speed would only slowdown as much as needed to ensure that the part stays on the build plate.

The maximum allowable force may be predetermined based on the area of material cured in the first layer (i.e. the layer attached directly to the build plate). The maximum allowable force may also take into account the minimum area between two previously printed successive layers. For example, if printing a vertical hour-glass shape, it may be important to ensure that the object doesn't break at the narrowest or most fragile spot. Therefore, in such a case, the maximum allowable force may be reduced as the area of the printed layers decrease (and may not increase again as the printed layers increase again). The maximum allowable force may be predetermined based on the area of material cured in the last-cured layer (i.e. the layer attached directly to the release layer).

The method used to control the release mechanism is shown in FIG. 3. As shown in FIG. 3, after a layer is cured, the release layer is lowered using the actuators. Then the force sensor (in this case the load cell connected to the build plate) for each actuator is used to determine the load value. If the load value is above an allowable threshold, the speed of the build plate is reduced, and the force sensor value is determined again. If the load value is below an allowable threshold and there has not been a sudden drop in force, the speed of the build platform is maintained, and the force sensor value is determined again. When there is a sudden drop in measured force (e.g. in one or more of the actuators) indicative of release of the cured layer, the system is configured to prepare the system for printing the next layer. The build plate is moved one-layer thickness upwards and the actuators raise the release layer to its original position. The thickness of a layer may be, for example, between 0.05 mm and 0.15 mm (or 0.001 mm and 0.5 mm). Then the curing process can restart. In this way, the object is built up layer by layer.

### 6-DoF Mount 3D Printer

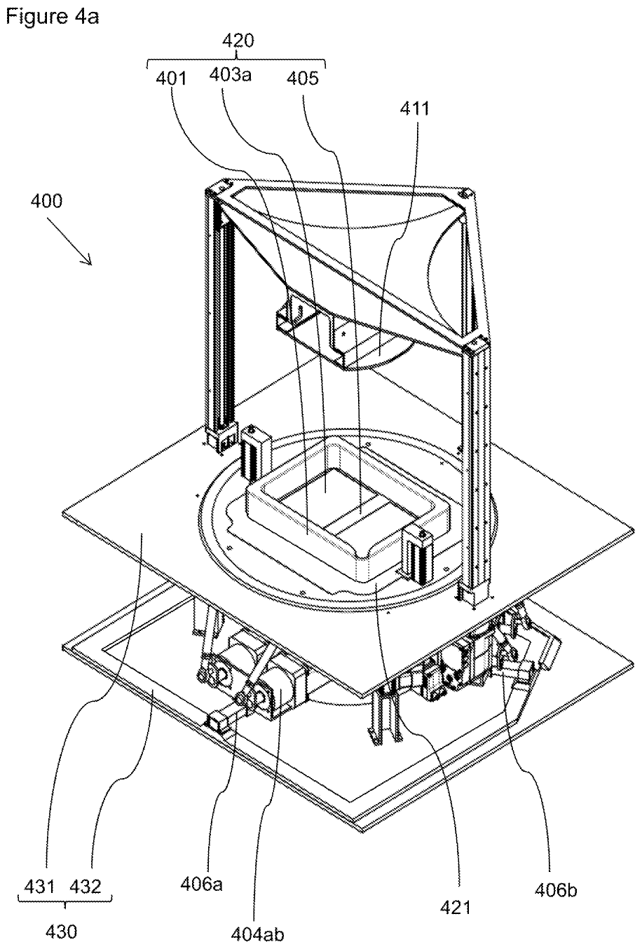

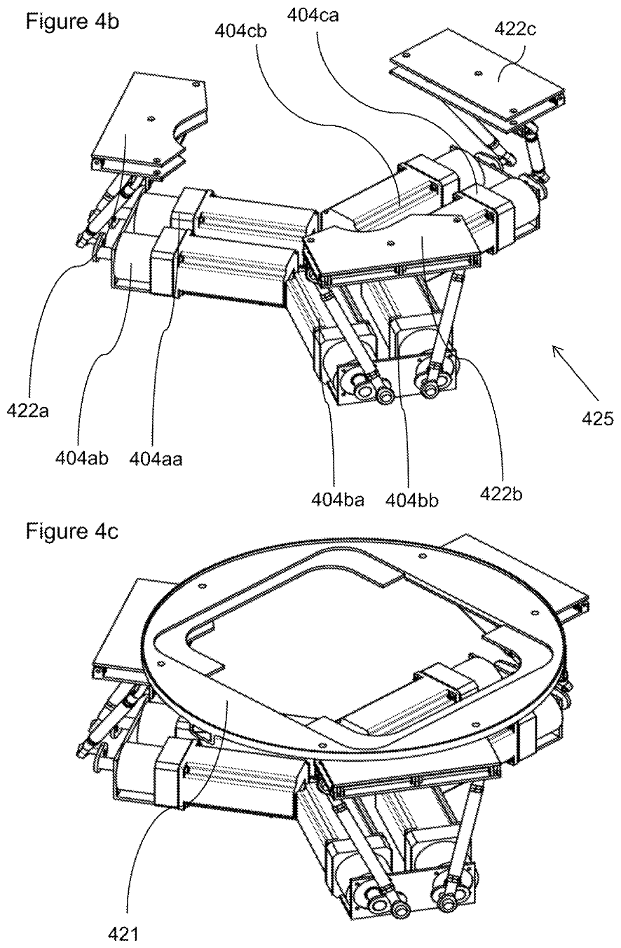

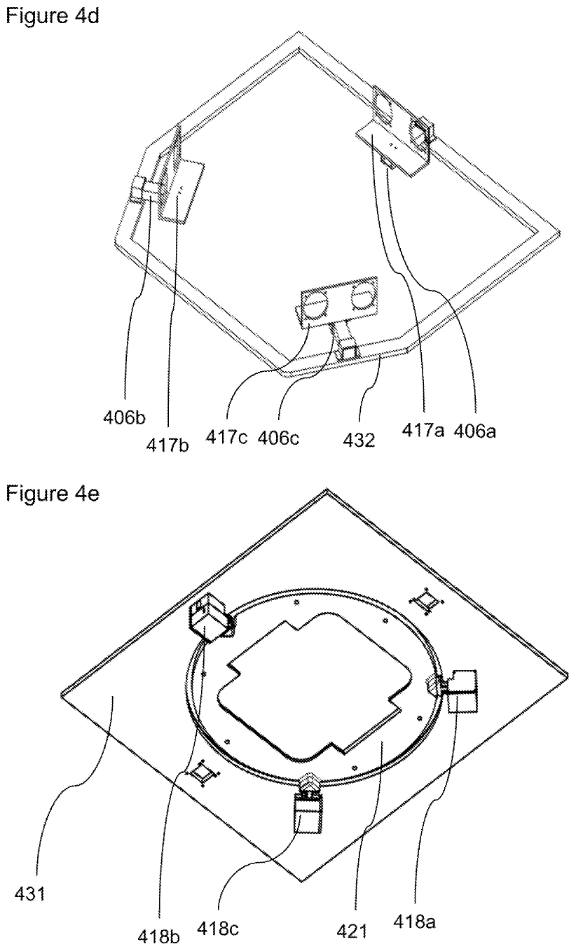

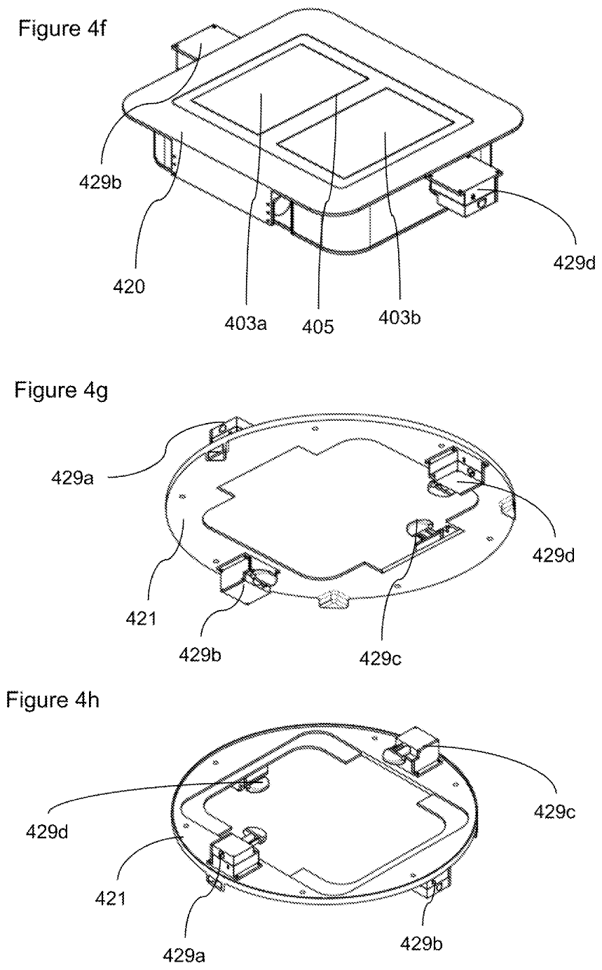

FIG. 4a shows a further embodiment of a 3D printer comprising a release assembly 400. FIGS. 4b-e show particular components of the release assembly. The release assembly apparatus comprises:
a vat 401 configured to contain solidifiable resin and having a release layer 405, the release layer being configured to transmit solidification energy from a solidification energy source 403a into the vat of solidifiable resin to solidify at least a portion of the solidifiable resin in contact with the release layer;
a configuration mechanism including a build plate 411 for supporting an object being printed, the configuration mechanism being configured to control the position of the object with respect to the release layer 405; and
one or more force sensors 406a-c configured to measure the force applied to the object as it is moving with respect to the release layer.

In this case, the release assembly comprises three sub-assemblies or units which are configured to move with respect to each other. These sub-assemblies include: the frame 430, the build plate 411 and the solidification unit 420. The build plate 411 and the solidification unit 420 are each independently connected via respective actuators to the frame 430 which means that the frame effectively defines a stationary frame of reference. The frame may be rigidly connected to the base of the 3D printer so that the frame does not move with respect to the floor. Therefore, in this case, the configuration mechanism includes the actuators which can move the release layer with respect to the frame, and the actuators which can move the build plate (and attached object) with respect to the frame.

The frame 430 in this case comprises a base 432 and a raised platform 431 which are rigidly fixed with respect to each other (e.g. using legs, walls or other vertical supports). The frame raised platform 431 is at a similar level to the solidification unit 420.

In this case, as shown in FIGS. 4b and 4c, the actuators connecting the solidification unit to the frame is in the form of a 6-DoF mount 425, the 6-DoF mount comprising six actuators 404aa, 404ab; 404ba, 404bb; 404ca, 404cb configured to control the position of the release layer (which is part of the solidification unit in this case) with respect to the frame.

In this embodiment, the bottom of the 6-DoF mount is connected to the base of the frame 432. The solidification unit 420 is configured to sit on a solidification unit platform 421. FIG. 4b shows the 6-DoF mount without the solidification unit platform, and FIG. 4c shows the 6-DoF mount with the solidification unit platform 421. The solidification unit platform 421 is a rigid base which is connected to all 6 actuators of the 6-DoF mount 425 via six arms. This means that the 6-DoF can control the motion of this platform 421 with respect to the frame in any of the 6 degrees of freedom by moving in consort.

In this case, the six actuators 404aa-cb are rotary actuators. In the context of this technology, measuring the forces as the 6-DoF mount is moving, rotatory actuators were found to offer advantages over hydraulic actuators. Firstly, because the centre of mass moves less as the actuators are actuated because the actuators are lighter; and secondly because the movement of the centre of mass is more predictable the actuators are self contained and fluid lines do not have to be taken into account.

The rotary actuators in this embodiment each comprise a shaft which is connected to a projection which extends laterally from the shaft axis. This projection is in turn connected to the proximal end an arm which extends upwards at an angle. As the shaft rotates around the axis, the projection rotates which moves the arm. The arms are constrained by being connected to a rigid plate (the solidification unit platform) at their distal ends.

In this case, the six rotary actuators of the 6-DoF mount 425 are arranged in pairs as shown in FIG. 4b. In this case, when the solidification unit is in place for printing and/or for effecting separation, the projections of each pair of actuators are configured to be directed towards each other. This brings the proximal ends of the arms closer together which helps provide greater control of the solidification unit. The solidification unit may be configured to allow a movement of at least 50 mm in any direction from the locked printing position.

One of the force sensors are positioned below each of the rotary actuator pairs as shown in FIG. 4d. That is, each pair of rotary actuators are mounted on a common actuator pair mount 417a-c, each of which is connected to the frame base 432 via a respective force senor 406a-c. This means that the force sensors are directly below the proximal ends of the 6-DoF mount arms which helps to increase responsiveness. It will be appreciated that more force sensors may be used, but three force sensors allow 6 parameters to be determined including the absolute force on each of the three force sensors and the difference between three pairs of force sensors. These 6 parameters provide a sufficient understanding of the forces being applied to the release layer during release to allow the printer to control the 6-DoF mount. The force sensors in this case are strain gauges and each can measure loads of between 40 g-30 kg.

In this case, as shown in FIG. 4e, the release assembly comprises a platform-frame lock having three pairs 418a-c of complementary platform-frame engagement members configured to releasably lock the release layer in fixed position with respect to the frame in a reproduceable relative position. In this case, the platform-frame lock engages directly between the raised platform 431 and the solidification unit platform 421 (which in turn is rigidly connected to the release layer). That is, the frame in this case may be considered to be a structure which spans across both ends of the release layer actuators, which when locked by the platform-frame lock prevents the actuators moving the release layer with respect to the frame.

After a layer has been printed, the platform-frame lock is released which allows the solidification unit (and the release layer) to be moved using the 6-DoF mount to effect release. That is, the 6-DoF mount will move generally downwards to exert a separation force between the release layer and the newly printed layer. Based on the measured forces and on the shape of the object being printed, the 6-DoF mount may use any of its six motions to help ensure that separation occurs quickly and without damage to the object being printed.

After the object has been released, which as before can be detected by the force measurements, the assembly is configured to return the solidification unit to its original position. This reduces the time between printing steps.

During this return movement, the 6-DoF mount is configured to tilt the release layer 405 such that the release layer is not parallel with the build plate 411 (or to the previously printed layer) as the as the build plate and the release layer are moving towards each other. Again, the speed of the return can be based on the force measured by the force sensors. It will be appreciated that the force measuring during the return stage is related to pushing the resin out from between the release layer and the last printed layer. Controlling the speed based on this force allows the return speed to be as fast as possible to speed printing, while keeping the forces low enough so as not to damage the printed product. It may also allow more viscous resins to be used. When the release layer is at the correct height the 6-DoF mount returns the release layer to be parallel to the build plate.

In this embodiment, after release and while the solidification unit is still free to move, the force on the force sensors is recorded to provide an indication of the weight of the assembly above the force sensors. This can be used as a baseline to account for the weight when the next separation stage occurs.

When the release layer is in position for the next curing stage, the platform-frame lock 418a-c is engaged to lock the release layer in fixed position with respect to the frame. This is shown in FIG. 4e which shows the underside of the frame raised platform locked to the solidification unit platform 421. In this case, the solidification unit platform comprises three female connectors and the frame comprises three corresponding male connectors. The male connectors are tapered to help align the male and female connectors. The taper in this case is configured to start to engage the female members even when the solidification unit is rotated about a vertical axis (e.g. but is otherwise level or oriented correctly horizontally). As the platform-frame lock fully engages, the solidification unit can rotate to back a predetermined, consistent and reproducible orientation with respect to the frame. The male connectors are configured to be inserted laterally (e.g. horizontally or perpendicular to the printing axis) to engage the female connectors. The lateral engagement of the male members prevent twisting of the release layer relative to the frame. Engaging the platform-frame lock helps ensure that the position of the release layer is the same during each curing stage. In addition, it helps ensure that any movement of material (e.g. relating to resin being added to the vat) does not induce motion to the release layer because of play in the 6-DoF mount actuators.

In this embodiment, the 6-DoF mount is connected to the solidification unit via a resilient mount. In this case, the resilient mount comprises three spring-biased hinged plate pair assemblies. In this embodiment, each pair of actuators are associated with a respective plate pair assembly. In each of these hinged plate pair assemblies, the hinges are arranged towards the outside and the springs are positioned between the facing sides of the plates. It will be appreciated that other embodiments may use other resilient biasing means such as an elastic material or one or more flexible cavities comprising a compressible gas. In this embodiment, the hinge axis is configured to be parallel to an axis which is perpendicular to both shaft axes of the pair of actuators to which the hinged plate pair assembly is connected. This helps ensure that movement of the actuator pair is accurately transmitted to the top plate while allowing some play in movement of the top plate when movement is induced indirectly from the other actuator pairs.

The hinged plate pair assemblies help level the solidification unit prior to printing the next layer. As the 6-DoF mount raises the solidification unit, the top plate of each hinged plate pair assembly abuts the bottom surface of the raised platform. The resiliency of the resilient mount allows the 6-DoF mount to continue to be adjusted as the top plates align with the bottom surface of the raised platform. This helps level the solidification unit without having to rely on precisely adjusting the 6-DoF mount. This means that the bottom of the solidification unit platform can be more easily brought into alignment with the raised platform and the platform-frame lock. That is, the bottom of the raised platform may be considered to be a hard stop to halt the upward movement of the solidification unit at the correct height and orientation.

The resilient mount is configured such that, when the solidification unit is locked to the frame using the platform-frame lock, the actuators of the 6-DoF mount can be raised slightly to compress the resilient mount. This may help ensure a more reproducible release layer position with respect to the frame by further restricting movement of the platform-frame lock.

The build plate 411 in this embodiment is connected to the frame 430 and is configured to move up and down along a single axis along three pillar guides. Using three or more pillar guides means that the build plate can be kept level. During the printing of an object, the build plate may move only upwards in increments corresponding to the layer thicknesses. That is, because the separation is facilitated by moving the release layer downwards using the 6-DoF mount, there may be a reduced need to raise the build plate up to effect separation and then down again to allow the next layer to be printed. Allowing the release layer and the build plate to move independently may allow the actuators to be tailored to their function. For example, the actuator used to move the build plate one-layer thickness at a time may be configured to be more accurate than if the build plate were required both to effect separation and to define the layer thickness.

In this embodiment, the vat (including the release layer) and the solidification energy source are joined together as a rigid solidification unit, and the release assembly comprises a platform-unit lock 429a-d having complementary platform-unit engagement members configured to releasably lock the solidification unit to the 6-DoF mount. The solidification unit is shown in FIG. 4f (without the vat walls for clarity). FIGS. 4g and 4h are respective bottom and top perspective views of the solidification unit platform 421 two which the solidification unit can engage and lock using a platform-unit lock.

This allows the solidification unit 420 to be easily removed and replaced. In the context of 3D printers, the LCD is an element which may be prone to malfunction. This is particularly the case for large printer beds with a large number of pixels. Allowing the solidification unit to be easily removed as a unit can help reduce downtime on the printer. Another solidification unit can be quickly put into the printer to allow printing to continue while the removed solidification unit is repaired.

In this embodiment, as shown in FIGS. 4f, 4g and 4h the platform-unit lock has four engagement member pairs 429a-d. Two of the member pairs 429a,c are positioned above the solidification unit platform 421 and the other two 429b,d are positioned below the solidification unit platform 421. In this case, the solidification unit comprises four female connectors and the solidification unit platform comprises four corresponding male connectors. The male connectors are tapered to help align the male and female connectors. The male connectors are configured to be inserted laterally (e.g. horizontally or perpendicular to the printing axis) to engage the female connectors. The platform-unit lock may be manual or powered.

In this case, to help align the solidification unit, the solidification unit platform 421 comprises a hole configured to conform to the shape of the solidification unit and a support surface so that the solidification unit can sit on the support surfaces before the platform-unit lock is engaged. It will be appreciated that the platform-unit lock will allow a downward force to be applied to the solidification unit as the solidification unit platform is lowered with respect to the build plate by controlling the 6-DoF mount.

### 5-DoF Mount 3D Printer

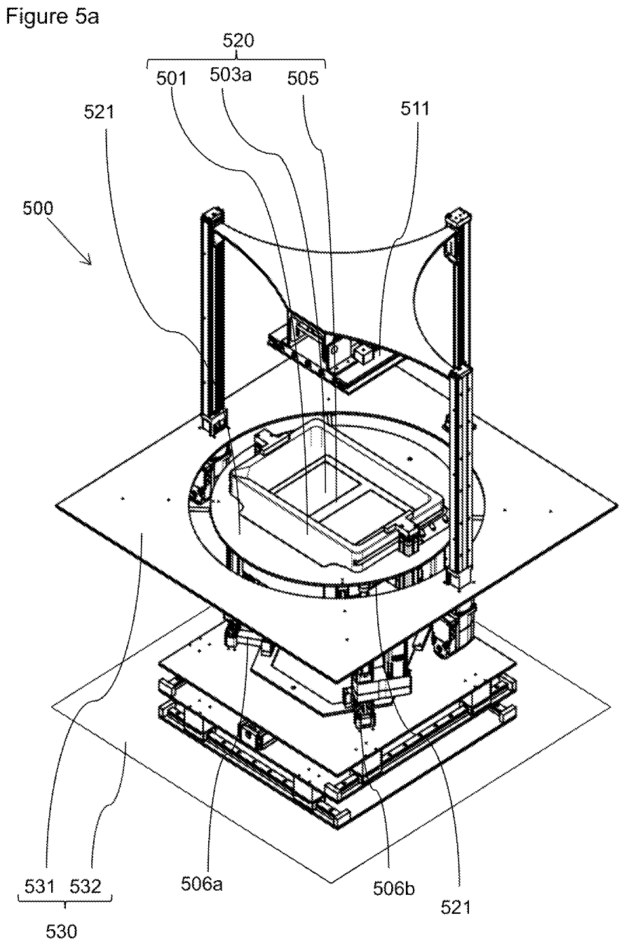

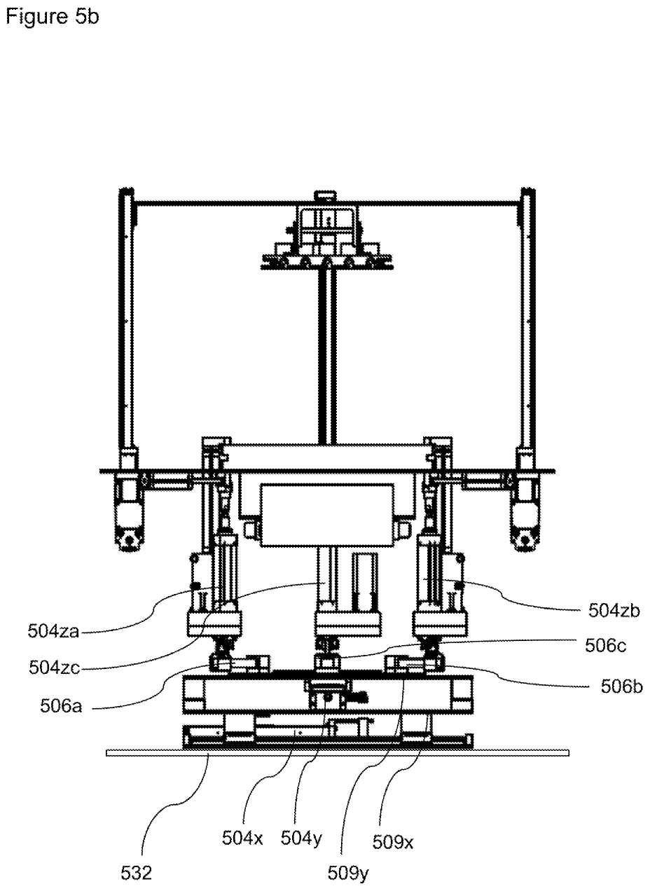

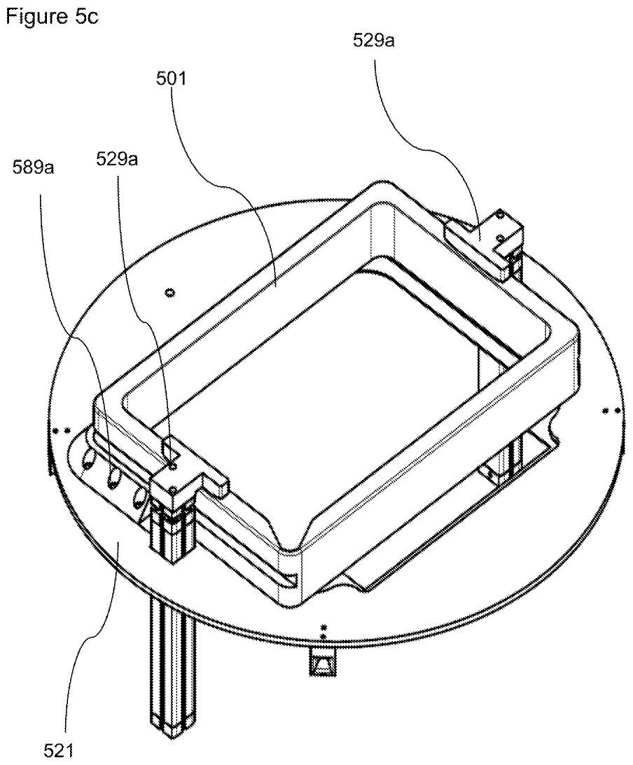

FIGS. 5a and 5b shows a further embodiment of a 3D printer comprising a release assembly 500. FIG. 5c shows particular components of the release assembly. The release assembly apparatus 500 comprises:
a vat 501 configured to contain solidifiable resin and having a release layer 505, the release layer being configured to transmit solidification energy from a solidification energy source 503a into the vat of solidifiable resin to solidify at least a portion of the solidifiable resin in contact with the release layer;
a configuration mechanism including a build plate 511 for supporting an object being printed, the configuration mechanism being configured to control the position of the object with respect to the release layer 505; and
one or more force sensors 506a-c configured to measure the force applied to the object as it is moving with respect to the release layer.

As with other previously described embodiments, the release assembly comprises three sub-assemblies or units which are configured to move with respect to each other. These sub-assemblies include: the frame 530, the build plate 511 and the solidification unit 520. The build plate 511 and the solidification unit 520 are each independently connected via respective actuators to the frame 530 which means that the frame effectively defines a stationary frame of reference. The frame may be rigidly connected to the base of the 3D printer so that the frame does not move with respect to the floor. Therefore, in this case, the configuration mechanism includes the actuators which can move the release layer with respect to the frame, and the actuators which can move the build plate (and attached object) with respect to the frame.

The frame 530 in this case comprises a base 532 and a raised platform 531 which are rigidly fixed with respect to each other (e.g. using legs, walls or other vertical supports). The frame raised platform 531 is at a similar level to the solidification unit 520.

In this case, as shown in FIG. 5b, the actuators connecting the solidification unit to the frame is in the form of a 5-DoF mount, the 5-DoF mount comprising multiple upright actuators 504za-zc with arms forming part of a 3-DoF mount, and two lateral actuators 504x, y forming part of a sliding-floor mount. The force sensor in this embodiment are positioned between the 3-DoF mount and the sliding floor mount to limit the weight on the force sensors (or at the bottom of each of the upright actuators).

The 5-DoF mount is configured to control the position of the release layer (which is part of the solidification unit in this case) with respect to the frame.

The upright actuators provide 3 degrees of freedom including tilting in two directions and translation up and down. It will be appreciated that there may be more that three upright actuators. For example, in some embodiments, there may be four upright actuators positioned adjacent to four corners of the vat.

In some embodiments, the area between the points at which the actuators connect to the solidification unit may extend beyond the area of the release layer. This means that when any of the actuators are lowered, none of the area of the release layer (e.g. within the vat) rises by pivoting about another stationary actuator. This may reduce damage to the object being printed.

The bottom end of each upright actuator 504za-zc is mounted on a hinge to the force sensor. The axis of each upright-actuator hinge is configured to be horizontal and perpendicular to a line between the bottom of the upright actuator and the centre of the device. That is, the hinges are mounted tangentially around a circumference which would allow the actuator and arm to move radially in and out. This ensures that the hinges cannot move in consort to move the release layer laterally. The tops of the upright actuator arms are connected with a joint which permits freedom of rotation and tilting (e.g. a universal joint, a swivel mount, a ball and socket joint or a heim joint).

The lateral actuators 506x,y are configured to move the release layer in different respective lateral directions. In this embodiment, one lateral actuator 506x is configured to enable lateral movement of a first subfloor 509x with respect to the frame 532 in a first direction (back and forth). A second lateral actuator 506y is configured to enable lateral movement of a second subfloor 509y with respect to the first subfloor 509x. Each of the subfloors are mounted on rails to help restrict the relative movement of the actuator to one axis each.

Through operation of the two lateral actuators, the second subfloor 509y can move in any lateral direction with respect to the frame 532. This provides two additional degrees of freedom. In this embodiment, the two actuators are configured to move the subfloors 509x,y in orthogonal or perpendicular directions. Any other two directions may also work, provided that they were not aligned. The two actuators are each configured to cause motion which is parallel to the release layer when the release layer is in its printing position.

The vertical actuators are mounted on the second subfloor. The actuators 504za-zc, 504x, 504y acting in consort permit the following motions:
Translational envelopes:
   Moving forward and backward on the X-axis. (Surge)
   Moving left and right on the Y-axis. (Sway)
   Moving up and down on the Z-axis. (Heave)
Rotational envelopes:
   Tilting side to side on the X-axis. (Roll)
   Tilting forward and backward on the Y-axis. (Pitch)

It will be appreciated that some of these individual movements may be simpler to implement using the 5-DoF system as compared to the 6-Dof system of the previous embodiment. For example, a lateral sway motion on the Y-axis may be implemented using a single actuator in the present 5-DoF system, whereas the equivalent motion in the 6-DoF system of the previous embodiment would require the coordinate motion of all 6 actuators. Therefore, an advantage of this embodiment is that the motions of the actuators better map on to the motions typically required to effect separation, while still providing multiple degrees of freedom for more complex motions.

As in the previous embodiment, the solidification unit 520 is configured to sit on a solidification unit platform 521. The solidification unit platform 521 is a rigid base which is connected to 3 actuators of the upright actuators. This means that the 5-DoF can control the motion of this platform 521 with respect to the frame in any of the 5 degrees of freedom by moving in consort.

The range of motion may be at least 60 mm in any direction. Larger build areas may have a higher vertical range of motion. For example, some large area release layers may be able to move the release layer down from the printing position by as much as 300 mm.

One of the force sensors are positioned below each of the upright actuators as shown in FIG. 4b. This means that the force sensors are directly below the proximal ends of the 3-DoF mount arms which helps to increase responsiveness. It will be appreciated that there will be one force sensor for each upright actuator, but three force sensors allow 6 parameters to be determined including the absolute force on each of the three force sensors and the difference between three pairs of force sensors. These 6 parameters provide a sufficient understanding of the forces being applied to the release layer during release to allow the printer to control the 5-DoF mount. The force sensors in this case are strain gauges and each can measure loads of between 40 g-30 kg.

In this embodiment, with the vat having an object stuck to it, the vertical actuators and arms forms the corners of a polygon (a triangle in this case). As the release layer is lowered (e.g. along the z-axis), the separation force may increase on all three force sensors. As the lateral actuators are used to move in the x-y axes, the separation forces will increase differently for the force sensors. That is, lateral motion can be used to apply differential forces across the various force sensors. It will be appreciated that combinations of movements will be used (including vertical and lateral motions), which will result in a combination of the forces during the pulling to create a separation.

As in the previous embodiment, the release assembly comprises a platform-frame lock having multiple pairs (four in this case) of complementary platform-frame engagement members configured to engage with each other to releasably lock the release layer in fixed position with respect to the frame in a reproduceable relative position. In this case, the platform-frame lock engages directly between the raised platform 531 and the solidification unit platform 521 (which in turn is rigidly connected to the release layer). That is, the frame in this case may be considered to be a structure which spans across both ends of the release layer actuators, which when locked by the platform-frame lock prevents the actuators moving the release layer with respect to the frame. In this case, the platform-frame lock is pneumatically actuated and controlled by a controller.

After a layer has been printed, the platform-frame lock is released which allows the solidification unit (and the release layer) to be moved using the 5-DoF mount to effect release. That is, the 5-DoF mount will move generally downwards to exert a separation force between the release layer and the newly printed layer. Based on the measured forces and on the shape of the object being printed, the 5-DoF mount may use any of its five motions to help ensure that separation occurs quickly and without damage to the object being printed.

After the object has been released, which as before can be detected by the force measurements, the assembly is configured to return the solidification unit to its original position. This reduces the time between printing steps.

During this return movement, the 5-DoF mount is configured to tilt the release layer 505 such that the release layer is not parallel with the build plate 511 (or to the previously printed layer) as the as the build plate and the release layer are moving towards each other. Again, the speed of the return can be based on the force measured by the force sensors. It will be appreciated that the force measuring during the return stage is related to pushing the resin out from between the release layer and the last printed layer. Controlling the speed based on this force allows the return speed to be as fast as possible to speed printing, while keeping the forces low enough so as not to damage the printed product. It may also allow more viscous resins to be used. When the release layer is at the correct height the 5-DoF mount returns the release layer to be parallel to the build plate.

In this embodiment, after release and while the solidification unit is still free to move, the force on the force sensors is recorded to provide an indication of the weight of the assembly above the force sensors. This can be used as a baseline to account for the weight when the next separation stage occurs.

When the release layer is in position for the next curing stage, the platform-frame lock is engaged to lock the release layer in fixed position with respect to the frame. In this case, the solidification unit platform comprises four female connectors and the frame comprises four corresponding male connectors. The male connectors are tapered (e.g. with a concave shape) to help align the male and female connectors. The male connectors are tapered in the vertical direction to help with vertical alignment, and in the lateral direction to help with rotational alignment around the vertical axis. As the platform-frame lock fully engages, the solidification unit can be rotated and translated back to a predetermined, consistent and reproducible orientation with respect to the frame. The male connectors are configured to be inserted laterally (e.g. horizontally or perpendicular to the printing axis) to engage the female connectors. The lateral engagement of the male members prevent twisting of the release layer relative to the frame. Engaging the platform-frame lock helps ensure that the position of the release layer is the same during each curing stage. In addition, it helps ensure that any movement of material (e.g. relating to resin being added to the vat) does not induce motion to the release layer because of play in the 6-DoF mount actuators.

The build plate 511 in this embodiment is connected to the frame 530 and is configured to move up and down along a single axis along three pillar guides. In this case, two of the pillars are configured to drive the build plate up and down and the third maintains the orientation of the build plate but is not driven. Other configurations of driven and non-driven pillars may be used.

In this case, no pillars are positioned on one side of the vat to allow the vat to be easily inserted and removed.

Using three or more pillar guides means that the build plate can be kept level. During the printing of an object, the build plate may move only upwards in increments corresponding to the layer thicknesses. That is, because the separation is facilitated by moving the release layer downwards using the 5-DoF mount, there may be a reduced need to raise the build plate up to effect separation and then down again to allow the next layer to be printed. Allowing the release layer and the build plate to move independently may allow the actuators to be tailored to their function. For example, the actuator used to move the build plate one-layer thickness at a time may be configured to be more accurate than if the build plate were required both to effect separation and to define the layer thickness.

In this embodiment, the vat (including the release layer) and the solidification energy source are held in place using a platform-unit lock 529a-b having complementary platform-unit engagement members configured to releasably lock the solidification unit to the 5-DoF mount.

In this embodiment, as shown in FIG. 5c the platform-unit lock has two complementary engagement member pairs 529a-b. In this case, the solidification unit comprises four female connectors and the solidification unit platform comprises two corresponding male connectors. The male connectors are tapered to help align the male and female connectors. The male connectors are configured to be inserted vertically to engage the female connectors. The platform-unit lock may be manual or powered.

In this case, to help align the solidification unit, the solidification unit platform 521 comprises a hole configured to conform to the shape of the solidification unit and a support surface so that the solidification unit can sit on the support surfaces before the platform-unit lock is engaged. To help with lateral positioning, the solidification unit platform also includes a wall barrier which, when the vat is abutting the wall barrier 589, the engagement member pairs of the platform-unit lock 529a-b are aligned. It will be appreciated that the platform-unit lock will allow a downward force to be applied to the solidification unit as the solidification unit platform is lowered with respect to the build plate by controlling the 6-DoF mount.

Unlike the previous embodiment, the vat and the solidification unit are not directly joined to each other. In this embodiment, the solidification energy source is inserted into the hole in the solidification unit platform, then the vat is slid in over the solidification energy source until it abuts the wall barrier 589. Then the vat is locked in place by lowering the platform-unit lock 529a-b, which locks the vat in place and traps the solidification energy source so it can not move with respect to the solidification unit platform 521. This allows the solidification unit 520 to be easily removed and replaced.

In the context of 3D printers, the LCD is an element which may be prone to malfunction. This is particularly the case for large printer beds with a large number of pixels. Allowing the solidification unit to be easily removed as a unit can help reduce downtime on the printer. Another solidification unit can be quickly put into the printer to allow printing to continue while the removed solidification unit is repaired.

### Machine Learning

The release assembly may be configured to record the forces on each actuator as a function of time in association with the configuration of each layer. The response of each actuator may also be recorded (e.g. the speed of each actuator as a function of time). This may be stored in conjunction with the resin, or properties of the resin used for printing that layer (e.g. one or more of viscosity of uncured resin, cure time, elastic modulus, yield point, ultimate strength, fracture point of cured resin). It will be appreciated that using properties of the resin may allow new resins to be used (or learned more quickly), provided some or all of its properties are known.

It will be appreciated that the stored information may be stored in association with the separation step and/or the approach step depending on what stage the release assembly was performing at the time that the information was recorded.

The system may be configured to receive information on the quality of the printed objects. This may be detected by the release assembly itself. For example, the release assembly may be configured to associate a particular temporal force profile with a breakage in the printed object, or detachment from the build plate during printing. For printing defects detected by the release assembly, the fault would be associated with the force profile being applied to the printed object at the time of the fault. For example, if damage occurred during approach, the system would recognize that the forces applied during this approach phase may have led to the printing fault.

In other embodiments, the printed objects may be inspected post printing. The results of the inspection may be processed along with the recorded data. It will be appreciated that the inspection may be a simple binary measure of whether the object was printed to an acceptable standard or not (e.g. pass/fail). The inspection may also seek to identify more specifically the nature of the fault. For example, if a particular layer was found to be faulty, this information may allow the processer to identify that fault with the recorded data around the time at which that layer was printed. Similarly, the inspection may seek to identify whether the nature of the defect was the result of tension or compression during the printing process. Tension defects may be associated with separation stages, and compression defects may be associated with approach stages.

The release assembly may be configured to reduce the number of printing defects (e.g. to a predetermined acceptable level) and increase the speed of printing. The release assembly may be configured to utilize machine learning to adjust the response of the actuators to the force profiles measures to achieve this.

For a new resin, the release assembly may be configured to undergo a series of standard print tests with a series of one or more standard objects in order to allow the system to adapt the response of the printer to that resin. This may be considered to be a learning phase. In addition, the system may be configured to continue to learn and refine the systems response on actual printing tasks (e.g. a normal phase) when feedback is provided. This may be particularly important for printing objects which are significantly outside the range of objects printed during the standard print tests.

One aspect of the machine learning is to have refine the estimates for the cure time of each layer and shape on the screen. Smaller shapes usually need a longer cure time than large shapes. By understanding the proper cure time for different sizes shape the system can estimate the proper cure time for each layer causing a baseline cure time.

The system will require that the forces for each layer be measured and stored. Once the print is completed the print is measured to determine the accuracy of the print and weigh that with the forces seen in the separation to determine the expected force from a given geometry and the variances in the actual part at different layers.

Along with the proper cure times the proper amount of supports can be estimated by changing the support properties in various prints and finding the best resulting prints for forces and part accuracy. 3D printing supports are not part of the desired object, but they are used (e.g. printed) to support parts of the model during printing. This means that once printing is over, the user has the additional task of removing the structures

The machine learning algorithm may begin by printing simple shapes (e.g. circles, squares, rings) at varying sizes and the system will measure the corresponding forces with different cure times on those slices. Then the object will be measured at the different layers. Measurements can be made using CMM's (coordinated measuring machine), 3d scanners, or by hand. Once measured the system will take in that data and determine the layers that had a proper cure time for that part and the forces that correspond to those layers. The average cure time for properly cured layer of each shape and size will be stored and used as a baseline for beginning the print.

Many layers of a 3D print could contain separated images of different sizes that each require different cure time. The system would also use the baseline data to determine the proper cure time for each image. The printer would then ensure each image is properly cured. It can do this in multiple ways. The first would be to reduce the UV power to the sections that require a short cure-time though dimming of light or creating a grey-scale image to make the cure-times of these sections the same as the smallest sections that require the longest cure-time for that slice. Another way to ensure that all images in a slice are properly cured is to simply black out each image as it hits its proper cure time.

After a large variance in sizes has been tested and the system is able to come up with a good estimate of the proper cure time with low enough margins of error the system should be able to interpolate the cure time and forces for any sizes between the sample sizes.

Knowing both the cure time and forces expected to properly cure the models the system can use the forces to check and update the cure-times. With forces lower then expected the cure times can be increase and vice versa.

After many simple shapes are tested the system will have to piece together the simple shapes in more complex shapes to the point where it will be-able to predict the result of almost any shape thrown at it.

On top of the layer shapes force profiles can be largely affected by the previous layers as well. Particularly large overhangs. In the case of hangs there can be a suction cup effect creating large forces. To further the system's intelligence overhangs and other features will have to be tested at different sizes shapes and offsets.

In conjunction with overhangs the system will have to determine the proper supports for the print. The right amount of supports will reduce the suction cup effect and reduce the forces required to separate but attach to the part and can leave mars were they are attached. This is not a variable that can be changed during the print but must be determined before beginning the print. So to test this prints with various support settings would be tested on varying overhangs to determine the proper supports required for each overhang. Support setting would include support density, contact size, support base size and support angle. After each print the print will be measured and compared with forces to determine the best support settings. The supports required are only dependent on the print geometry and not effected by temperatures and other hard to measure properties that change throughout a print so this variable does not need to be monitored and changed throughout the print and therefor can easily be determined before beginning the print with a database large enough to understand how the geometry will react.

### Other Options

The release assembly may comprise vibration actuators configured to vibrate the rigid release layer during separation. The vibration actuators may be positioned at the four corners of the release layer.

If the force remains above the threshold, the lift speed of the build plate may be reduced. However, if the cured layer is released from the release layer this will be detected by a sudden drop of force which will prompt the printer to quickly position the build plate such that the object is one-layer thickness away from the release layer ready for the next curing step.

The raising of the build plate and the raising of the release layer may occur simultaneously after separation. The build plate may be configured to rise at a speed no faster than the rising speed of the build plate. Raising both together may help prevent inflow of resin which would then need to be squeezed out. This may help reduce the force applied to the recently printed objection during approach.

The raising of the build plate may occur during separation. This may reduce the distance that the release layer has to be lowered during separation.

The release assembly may be configured to pause or stop vibration when a further force measurement is to be taken.

The release assembly may have the force sensor connected to the build plate.

Although the present invention has been described and illustrated with respect to preferred embodiments and preferred uses thereof, it is not to be so limited since modifications and changes can be made therein which are within the full, intended scope of the invention as understood by those skilled in the art.

1.-23. (canceled)

24. A release assembly apparatus for a 3D printer, the release assembly apparatus comprising:
a vat configured to contain solidifiable resin and having a release layer, the release layer being configured to transmit solidification energy from a solidification energy source into the vat of solidifiable resin to solidify at least a portion of the solidifiable resin in contact with the release layer;
a configuration mechanism including a build plate for supporting an object being printed, the configuration mechanism being configured to control the position of the object with respect to the release layer; and
one or more force sensors configured to measure the force applied to the object as it is moving with respect to the release layer.

25. The release assembly apparatus according to claim 24, wherein the release assembly comprises a frame and 3 Degrees of Freedom mount comprising multiple upright actuators configured to enable the release layer to tilt about two axes and to move up and down.

26. The release assembly apparatus according to claim 25, wherein each upright actuator is connected to the release layer via a universal joint.

27. The release assembly apparatus according to claim 25, wherein each upright actuator is mounted on a respective force sensor.

28. The release assembly apparatus according to claim 25, wherein the configuration mechanism is configured to control the actuators in order that the tilting axis rotates as the release layer is lowered.

29. The release assembly apparatus according to claim 25, wherein the configuration mechanism is configured to hold the release layer in a tilted configuration as it approaches the build plate.

30. The release assembly apparatus according to claim 25, wherein the configuration mechanism comprises one or more hard stops for halting the upward movement of the release layer at the correct position and orientation.

31. The release assembly according to claim 24, wherein the release assembly comprises a sliding-floor mount comprising multiple actuators configured to move the release layer laterally in any direction.

32. The release assembly apparatus according to claim 24, wherein the release assembly comprises a frame and wherein the configuration mechanism is configured to move the release layer with respect to the frame with at least 5 degrees of freedom.

33. The release assembly apparatus according to claim 24, wherein the release assembly comprises a frame and wherein the configuration mechanism comprises a 6 Degrees of Freedom mount, the 6 Degrees of Freedom mount comprising six rotary actuators configured to control the position of the release layer with respect to the frame.

34. The release assembly apparatus according to claim 33, wherein the six rotary actuators are mounted in pairs, and each pair of actuators is mounted to the frame via one of the force sensors.

35. The release assembly apparatus according to claim 25, wherein the release assembly comprises a platform-frame lock having complementary platform-frame engagement members configured to releasably lock the release layer in fixed position with respect to the frame in a reproduceable relative position.

36. The release assembly apparatus according to claim 25, wherein the mount is connected to the release layer via a resilient mount.

37. The release assembly apparatus according to claim 25, wherein the vat and the solidification energy source are joined together as a rigid solidification unit, and wherein the release assembly comprises a platform-unit lock having complementary platform-unit engagement members configured to releasably lock the solidification unit to the mount.

38. The release assembly apparatus according to claim 24, wherein the configuration mechanism comprises actuators configured to hold the release layer in a tilted configuration as the build plate and the release layer are moving towards each other.

39. The release assembly apparatus according to claim 24, wherein the release assembly is configured to adjust the approach speed of build plate towards the release layer based on the measured force.

40. The release assembly apparatus according to claim 24, wherein the release assembly is configured to assign a cure value for each area of the layer being printed and, based on the cure value, to adjust one or more of: the intensity and duration of the solidification energy from the energy source applied to each area.

41. The release assembly apparatus according to claim 24, wherein the release assembly is configured to increase separation speed if the force is below a low threshold value.

42. The release assembly apparatus according to claim 24, wherein the release assembly is configured to adjust how the configuration mechanism is controlled based on previous behavior of the configuration mechanism.

43. The release assembly apparatus according to claim 24, wherein the release assembly is configured to:
record data on measured forces on each of the force sensors as a function of time, configuration of each layer, and configuration of the configuration mechanism as a function of time,
store the recorded data in association with information on the resin being used;
receive feedback on the quality of the printed objects; and
adjust how the configuration mechanism responds to a measured force to reduce a rate of printing defects and increase the speed of printing.
